(19) United States
(12) Patent Application Publication
(10) Pub. No.: US 2025/0136369 A1
(43) Pub. Date: May 1, 2025

(54) SEMI-AUTONOMOUS REFUSE VEHICLE BACK-UP

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/925,778

(22) Filed: Oct. 24, 2024

Related U.S. Application Data
(60) Provisional application No. 63/593,624, filed on Oct. 27, 2023.

(51) Int. Cl. B65F 3/02; B60W 30/09; B60W 30/18

(52) U.S. Cl. CPC B65F 3/02; B60W 30/09; B60W 30/18036; B60W 2556/45

(57) ABSTRACT

A refuse vehicle, comprising a chassis, a user input device, at least one tractive element, at least one sensor for receiving sensor data related to the surrounding environment, and at least one processor. The processor receives the sensor data and processes it to identify non-drivable bounding areas. Additionally, the processor receives an indication from the user input device to autonomously operate the vehicle in reverse. In response to this indication, the processor autonomously adjusts one or more operating parameters to operate the vehicle in reverse and avoid the non-drivable bounding areas.

### CROSS-REFERENCE TO RELATED PATENT APPLICATIONS

This application claims the benefit of and the priority to U.S. Provisional Patent Application No. 63/593,624, filed Oct. 27, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

In some aspects, the techniques described herein relate to a refuse vehicle including: a chassis; a user input device; at least one tractive element; at least one sensor configured to receive sensor data associated with an environment proximate the refuse vehicle; at least one processor; and a non-transitory computer-readable medium containing instructions that when executed by the at least one processor causes the at least one processor to: receive the sensor data from the at least one sensor; process the sensor data to identify a non-drivable bounding area; receive an indication from the user input device to autonomously operate the refuse vehicle in a reverse direction; and responsive to receiving the indication from the user input device to autonomously operate the refuse vehicle in the reverse direction, autonomously adjust one or more operating parameters of the refuse vehicle to operate the refuse vehicle in the reverse direction to avoid the non-drivable bounding area.

In some aspects, the techniques described herein relate to a refuse vehicle, the at least one processor further configured to: responsive to receiving a second indication from the user input device, end the autonomous adjustment of the one or more operating parameters.

In some aspects, the techniques described herein relate to a refuse vehicle, wherein the non-drivable bounding area is associated with an overhead obstacle.

In some aspects, the techniques described herein relate to a refuse vehicle, wherein the indication is associated with an instruction to engage a refuse container.

In some aspects, the techniques described herein relate to a refuse vehicle, wherein the instructions further cause the at least one processor to: process the sensor data to identify a bounded drivable area and a safety threshold associated with the bounded drivable area; receive a second indication from the at least one sensor that the refuse vehicle is exceeding the safety threshold; and responsive to receiving the indication that the refuse vehicle is exceeding the safety threshold, execute a correction action.

In some aspects, the techniques described herein relate to a refuse vehicle, wherein the correction action includes autonomously adjusting, by the at least one processor, the one or more operating parameters to adjust a position of the refuse vehicle to be within the safety threshold.

In some aspects, the techniques described herein relate to a refuse vehicle, wherein the correction action includes autonomously transmitting, by the at least one processor, a notification of the exceeding of the safety threshold.

In some aspects, the techniques described herein relate to a refuse vehicle, wherein the notification is one of a visual notification, haptic notification, or audio notification.

In some aspects, the techniques described herein relate to a refuse vehicle, wherein an engagement assembly of the refuse vehicle is exceeding the safety threshold.

In some aspects, the techniques described herein relate to a non-transitory computer-readable medium containing instructions that when executed by one or more processors, cause the one or more processors to: receive sensor data from at least one sensor; process the sensor data to identify a non-drivable bounding area; receive an indication from a user input device to autonomously operate a refuse vehicle in a reverse direction; and responsive to receiving the indication from the user input device to autonomously operate the refuse vehicle in the reverse direction, autonomously adjust one or more operating parameters of the refuse vehicle to operate the refuse vehicle in the reverse direction to avoid the non-drivable bounding area.

In some aspects, the techniques described herein relate to a non-transitory computer-readable medium, wherein the instructions further cause the one or more processors to: process the sensor data to identify a bounded drivable area and a safety threshold associated with the bounded drivable area; receive a second indication from the at least one sensor that the refuse vehicle is exceeding the safety threshold; and responsive to receiving the indication that the refuse vehicle is exceeding the safety threshold, execute a correction action.

In some aspects, the techniques described herein relate to a non-transitory computer-readable medium, wherein the correction action includes autonomously adjusting, by the one or more processors, the one or more operating parameters to adjust a position of the refuse vehicle to be within the safety threshold.

In some aspects, the techniques described herein relate to a non-transitory computer-readable medium, wherein the correction action includes autonomously transmitting, by the one or more processors, a notification of the exceeding of the safety threshold.

In some aspects, the techniques described herein relate to a non-transitory computer-readable medium, wherein the notification is one of a visual notification, haptic notification, or audio notification.

In some aspects, the techniques described herein relate to a non-transitory computer-readable medium, wherein the instructions further cause the one or more processors to: responsive to receiving a second indication from the user input device, end the autonomous adjustment of the one or more operating parameters.

In some aspects, the techniques described herein relate to a non-transitory computer-readable medium, wherein the non-drivable bounding area is associated with an overhead obstacle.

In some aspects, the techniques described herein relate to a non-transitory computer-readable medium, wherein the indication is associated with an instruction to engage a refuse container.

In some aspects, the techniques described herein relate to a computer-implemented method for operating a refuse vehicle including: receiving, by one or more processors, sensor data from at least one sensor; processing, by the one or more processors, the sensor data to identify a non-drivable bounding area; receiving, by the one or more processors, an indication from a user input device to autonomously operate the refuse vehicle in a reverse direction; and responsive to receiving the indication from the user input device to autonomously operate the refuse vehicle in the reverse direction, autonomously adjusting, by the one or more processors, one or more operating parameters of the refuse vehicle to operate the refuse vehicle in the reverse direction to avoid the non-drivable bounding area.

In some aspects, the techniques described herein relate to a computer-implemented method, further including: processing, by the one or more processors, the sensor data to identify a bounded drivable area and a safety threshold associated with the bounded drivable area; receiving, by the one or more processors, a second indication from the at least one sensor that the refuse vehicle is exceeding the safety threshold; and responsive to receiving the indication that the refuse vehicle is exceeding the safety threshold, executing, by the one or more processors, a correction action.

In some aspects, the techniques described herein relate to a computer-implemented method, wherein the correction action includes autonomously adjusting, by the one or more processors, the one or more operating parameters to adjust a position of the refuse vehicle to be within the safety threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a block diagram of a vehicle autonomy system, according to an exemplary embodiment;

FIGS. 7A-7C are top views of the refuse vehicle of FIG. 1 with spatial awareness, illustrating the coverage zones of sensors and cameras, according to an exemplary embodiment;

FIG. 8 is a depiction of a vehicle executing the vehicle autonomy system of FIG. 6, according to an exemplary embodiment;

FIG. 9 is a flow diagram for autonomous guidance of a vehicle, according to an exemplary embodiment;

FIG. 10 is a flow diagram for aided guidance of a vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, various refuse collection vehicles are shown inclusive of a system configured to guide the refuse collection vehicle in a reverse direction. In some embodiments, the system may include various subcomponents, subsystems, processors, memory, databases, servers, communication modules, etc. In an exemplary embodiment, the system may include a vehicle awareness subsystem, a trajectory planning subsystem, and/or a vehicle control subsystem. The system (and its various subsystems) may receive sensor data from a sensor suite and an indication from a user input device to begin autonomous/semi-autonomous operation.

The vehicle awareness system may identify drivable surfaces, non-drivable surfaces, and/or objects positioned proximate the refuse collection vehicle. In addition, the vehicle awareness system may determine a position and orientation (and associated movement) of the refuse collection vehicle. In addition, the vehicle awareness system may record movements, adjustments, positions, orientations, and/or operating parameters of the refuse collection vehicle.

The trajectory planning subsystem may receive environmental data from the vehicle awareness system and the vehicle control system to generate a trajectory for the refuse collection vehicle to travel in which the refuse collection vehicle remains on an identified bounded drivable surface and avoids identified obstacles. In various embodiments, the trajectory is a back-up trajectory for the refuse collection vehicle to travel in a reverse direction and is planned so as to avoid collisions with any identified obstacles. In some embodiments, the trajectory planning subsystem may record movements of the refuse collection vehicle while driving and then plan the trajectory as a reverse of the recorded movements.

The vehicle control system may autonomously (or semi-autonomously) adjust operating parameters of the refuse collection vehicle to execute the planned trajectory from the trajectory planning subsystem. The vehicle control system may cause the adjustments directly or transmit instructions to one or more subsystems to execute the operating parameter adjustments.

### Refuse Vehicle

### Front-Loading Configuration

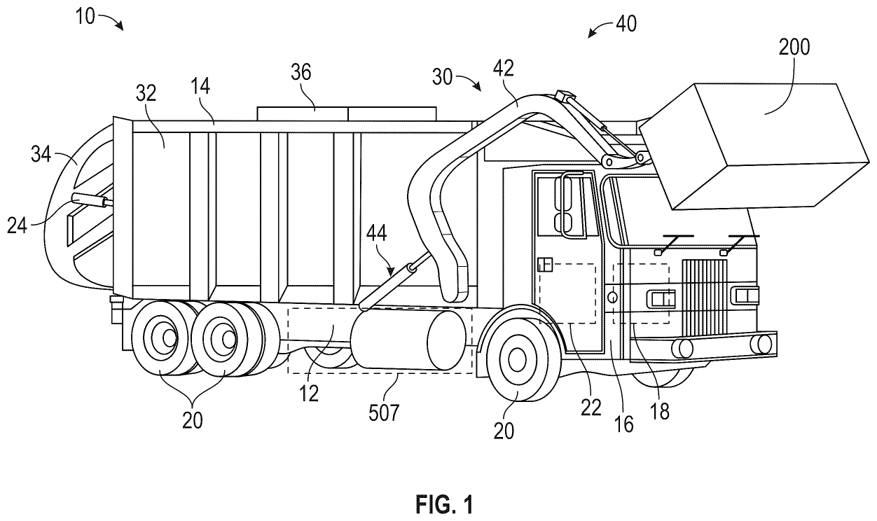

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment as described in greater detail in U.S. application Ser. No. 17/558,183, filed Dec. 12, 2021, the entire disclosure of which is incorporated by reference herein.

### Rear-Loading Configuration

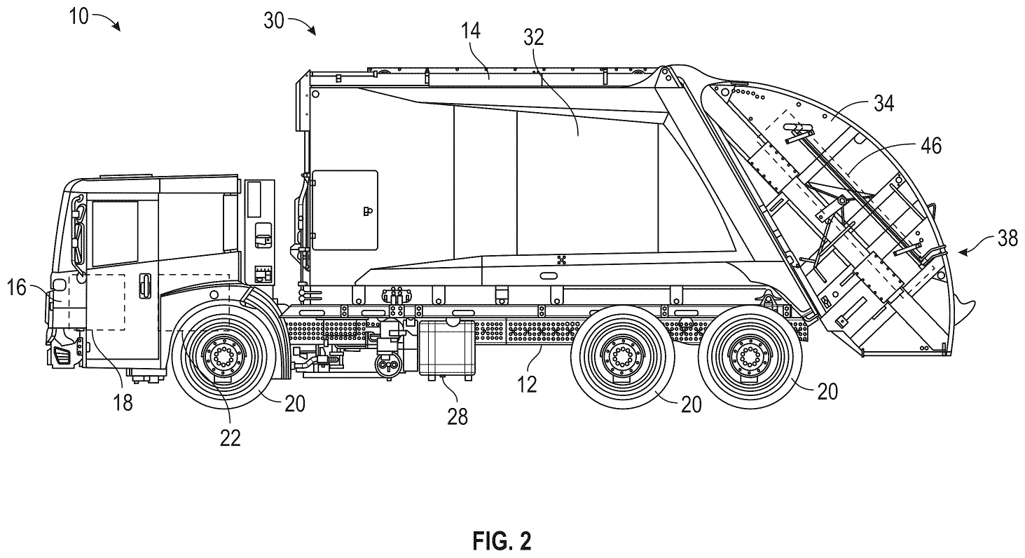

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

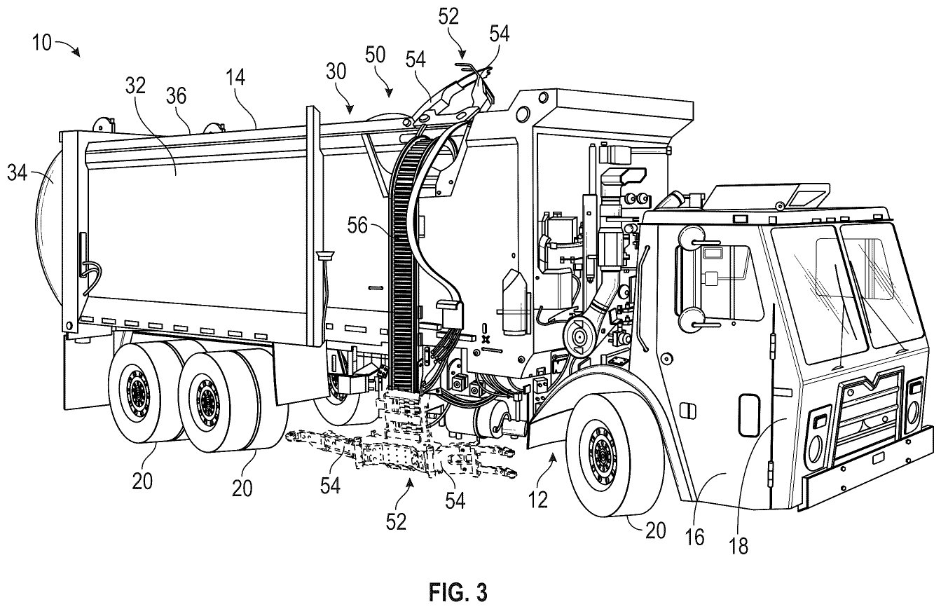

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

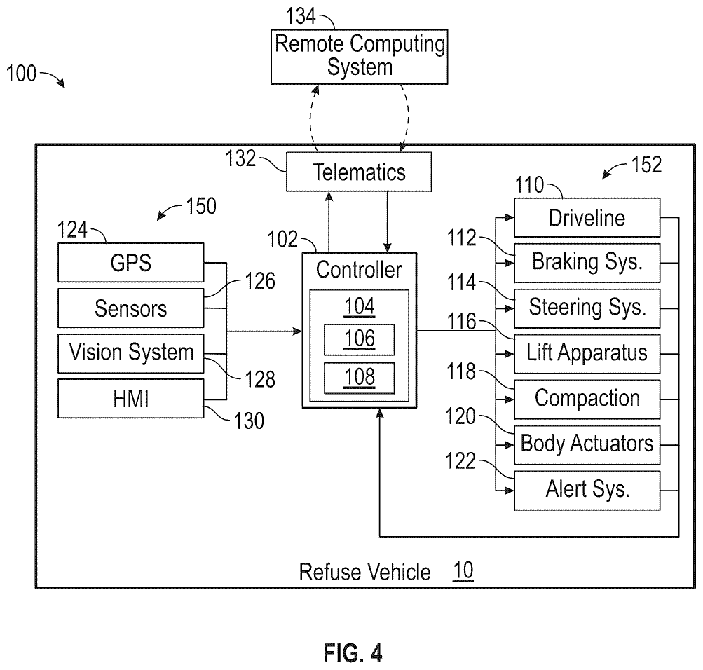

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

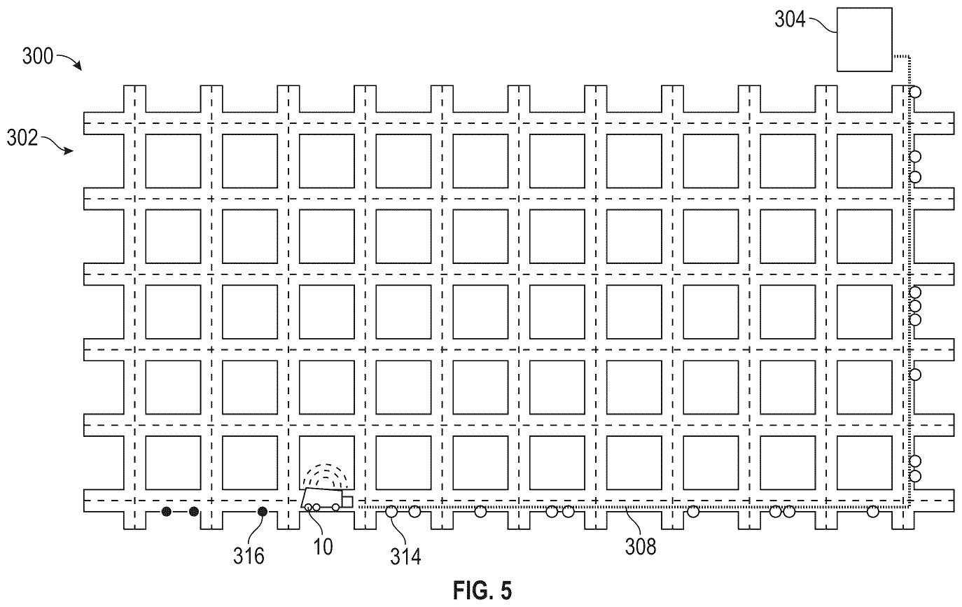

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Autonomy System

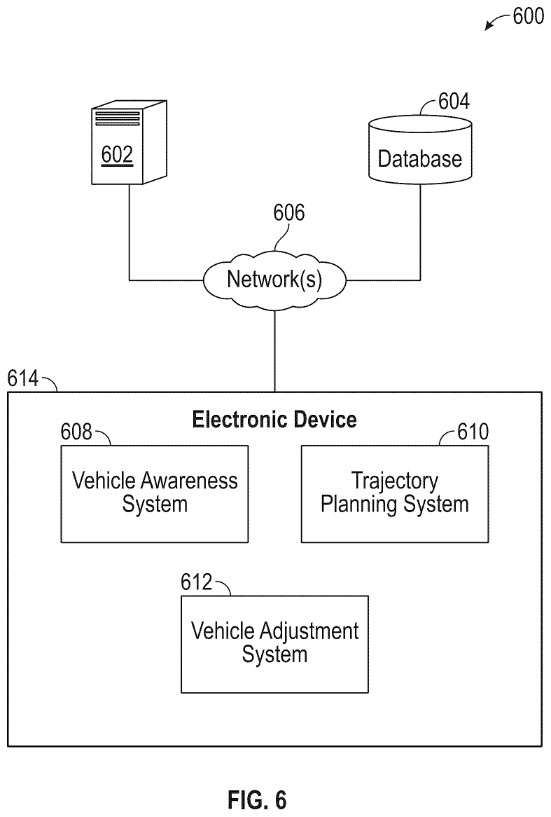

Referring to FIG. 6, a system 600 (e.g., an autonomy system) for executing autonomous/semi-autonomous guidance of a vehicle (e.g., refuse vehicle 10 of FIG. 1) is shown with various components and subsystems. The system 600 may include a server 602, a database 604, an electronic device 614. In some embodiments, the electronic device 614 is communicatively or physically coupled to the vehicle. The various devices and components of the system 600 may communicate with one another via one or more networks 606. In some embodiments, the system 600 may include a communication hub communicatively coupled to multiple vehicles and the various other components of the system 600 for facilitating communications between the various components of the system 600.

For ease of description and understanding, FIG. 6 depicts the system 600 as having only one or a small number of each component. Embodiments may, however, comprise additional or alternative components, or omit certain components, from those of FIG. 6 and still fall within the scope of this disclosure. As an example, it may be common for embodiments to include multiple servers 602 and/or multiple databases 604 that are communicably coupled to the server 602 and the electronic device 614 through the network 606. Embodiments may include or otherwise implement any number of devices capable of performing the various features and tasks described herein. For instance, FIG. 6 depicts the database 604 as hosted as a distinct computing device from the server 602, though, in some embodiments, the server 602 may include an integrated database 604 hosted by the server 602.

The system 600 includes one or more networks 606, which may include any number of internal networks, external networks, private networks (e.g., intranets, VPNs), and public networks (e.g., Internet). The networks 606 comprise various hardware and software components for hosting and conduct communications amongst the components of the system 600. Non-limiting examples of such internal or external networks 606 may include a Local Area Network (LAN), Wireless Local Area Network (WLAN), Metropolitan Area Network (MAN), Wide Area Network (WAN), and the Internet. The communication over the networks 606 may be performed in accordance with various communication protocols, such as Transmission Control Protocol and Internet Protocol (TCP/IP), User Datagram Protocol (UDP), and IEEE communication protocols, among others.

The electronic device 614 may include hardware components (e.g., one or more processors, non-transitory storage) and software components capable of performing the various processes and tasks described herein. Non-limiting examples of the electronic device within electronic device 614 include personal computers (e.g., laptop computers, desktop computers), server computers, mobile devices (e.g., smartphones, tablets), VR devices, and gaming consoles, smart watches, vehicle control boards, among other types of electronic devices. In some embodiments, the electronic device in the electronic device 614 may be the controller 102 of FIG. 4.

The electronic device 614 may include one or more subsystems and/or modules that when executed by the electronic device 614 to cause the electronic device 614 to perform various processes and methods as described herein. For example, the electronic device 614 may include a vehicle awareness system 608, a trajectory planning system 610, and/or a vehicle adjustment system 612. Although shown as separate and discrete subsystems, the vehicle awareness system 608, the trajectory planning system 610, and/or the vehicle adjustment system 612 may be a single system or split into additional subsystems. The separation of the vehicle awareness system 608, the trajectory planning system 610, and/or the vehicle adjustment system 612 into discrete subcomponents with discrete configurations and executable processes is for clarity of the disclosures and should not be interpreted in any way as limiting to scope of the disclosure. In some embodiments, the vehicle awareness system 608, the trajectory planning system 610, and/or the vehicle adjustment system 612 may be stored and/or executed by the server 602 and/or the database 604.

The server 602 may execute one or more software programs (e.g., the vehicle awareness system 608, the trajectory planning system 610, and/or the vehicle adjustment system 612) to perform various methods and processes described herein. The server 602 may include one or more computing devices configured to perform various processes and operations disclosed herein. In some embodiments, the server 602 may be a computer or computing device capable of performing methods disclosed herein. The server 602 may include a processor and non-transitory, computer readable medium including instructions, which, when executed by the processor, caused the processor to perform methods disclosed herein. The processor may include any number of physical, hardware processor. Although FIG. 6 shows only a single server 602, the server 602 may include any number of computing devices. In some cases, the computing devices of the server 602 may perform all or portions of the processes and benefits of the server 602. The server 602 may comprise computing devices operating in a distributed or cloud computing configuration and/or in a virtual machine configuration. It should also be appreciated that, in some embodiments, functions of the server 602 may be partly or entirely performed by the electronic device 614.

In an example, the electronic device 614 may execute one or more software programs to perform various methods and processes described herein. The electronic device 614 may include one or more computing devices configured to perform various processes and operations disclosed herein. In some embodiments, the electronic device 614 may be a computer or computing device capable of performing methods disclosed herein. In some embodiments, the electronic device 614 may be a mobile computing device (e.g., cellular device or tablet). In other embodiments, the electronic device 614 is an onboard vehicle controller (e.g., controller 102 of FIG. 4). The electronic device 614 may include a processor and non-transitory, computer-readable medium including instructions, which, when executed by the processor, caused the processor to perform methods disclosed herein. The processor may include any number of physical, hardware processors. Although FIG. 6 shows only a single electronic device 614, the electronic device 614 any include any number of computing devices. In some cases, the computing devices of the electronic device 614 may perform all or portions of the processes and benefits of the electronic device 614. The electronic device 614 may comprise computing devices operating in a distributed or cloud computing configuration and/or in a virtual machine configuration.

### Vehicle Awareness System

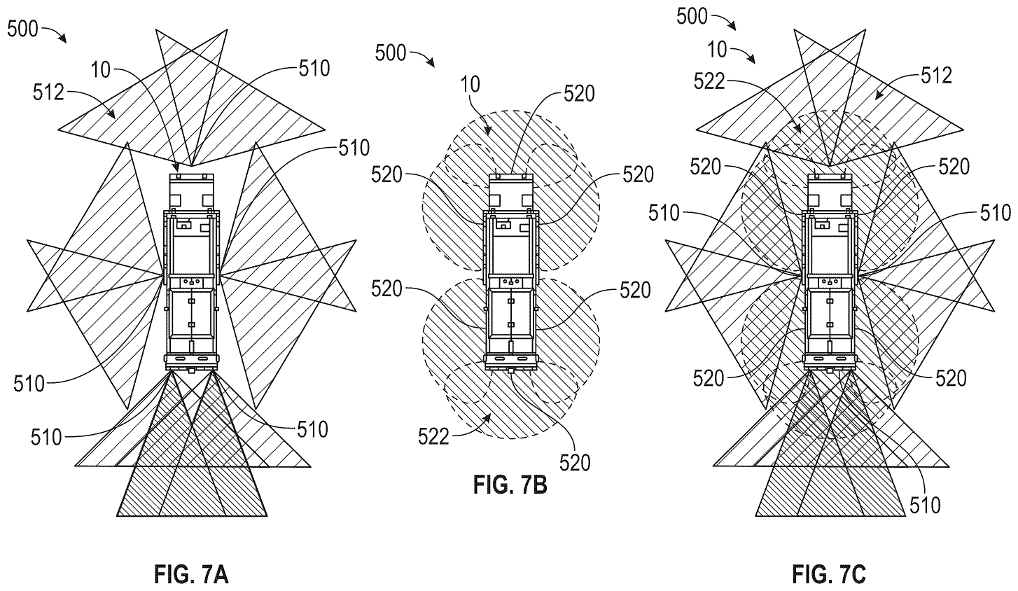

Turning now to FIGS. 7A-7C, an exemplary embodiment a vehicle 10 (e.g., the refuse vehicle 10 of FIG. 1) including one or more processors executing a vehicle awareness system 500. The vehicle awareness system 500 may be substantially similar to the vehicle awareness system 608 of FIG. 6. The processors may be hosted locally on the vehicle 10 and/or remotely (e.g., on the server 602 of FIG. 6). In one example, an autonomy system described herein may comprise several subsystems (e.g., the vehicle awareness system 500), components, processors, hardware, databases, servers, electronic device, instructions for execution etc. The described autonomy system may autonomously or semi-autonomously operate the vehicle based on various inputs. In an exemplary embodiment, the autonomy system includes the vehicle awareness system 500, as described in FIGS. 6-7C. The vehicle awareness system 500 may be similar to the spatial awareness system as described in greater detail in U.S. patent Ser. No. 11/630,201, filed Apr. 16, 2021, the entire disclosure of which is incorporated by reference herein. The autonomy system may be similar to the object detector 420 as described in U.S. application Ser. No. 17/189,740, filed on Mar. 2, 2021, the entire disclosure of which is incorporated by reference herein. The autonomy system may also be similar to the processes and systems described in U.S. patent Ser. No. 11/527,072, filed on Oct. 18, 2018, the entire disclosure of which is incorporated by reference herein.

Referring back to FIGS. 7A-7C, the autonomy system of the vehicle (e.g., the refuse vehicle 10 of FIG. 1) includes the vehicle awareness system 500 (e.g., a detection system, a vision system, an environmental detection system, an environmental awareness system, etc.) that is configured to detect and identify the environment surrounding the vehicle. The environment may include adjacent objects, approaching objects, lane lines, obstacles, drivable surfaces, etc. The vehicle awareness system 500 may be configured to detect different types of objects such as refuse containers, vehicles, buildings, fences, drainage, or any other object that may adjacent the refuse vehicle. The vehicle awareness system 500 may use a variety of sensors, detectors, emitters, detection sub-systems, etc., to detect different types of objects. For example, the vehicle awareness system 500 may use the vision system 128 or multiple of the sensors 126 of the refuse vehicle 10 in FIG. 1.

For example, the objects (e.g., refuse container) and the surrounding environment may be represented as a point cloud indicative of the position and orientation thereof relative to the vehicle 10 and/or the sensors (e.g., radar sensor(s), and/or the LIDAR sensor(s)). By way of example, the radar sensor(s) and/or the LIDAR sensor(s) may emit one or more signals (e.g., radio waves, laser beams, etc.) and sense the intensity of the reflections from the points where the signals reflected off surfaces of the objects and the surrounding environment. The vehicle controller are configured to detect and track movements of moving/stationary objects and characteristics thereof (as discussed in greater detail above) based on the vision data.

The vision data (e.g., point cloud data) may be used to generate a graphical representation (e.g., a two-dimensional representation, a three-dimensional representation) of the objects (e.g., the refuse container) and the surrounding environment to be displayed by the display. In some embodiments, the raw vision data (e.g., coordinates, distances, angles, speeds, etc.) of the objects and the surrounding environment are displayed by the display. In some embodiments, the radar sensor(s) and/or the LIDAR sensor(s) are configured to capture the vision data at a predetermined frequency (e.g., every second, every 500 milliseconds, at a frequency of about 5 Hz, 10 Hz, 50 Hz, 100 Hz, etc.) such that the graphical representation and the raw vision data of the objects and the surrounding environment are indicative of the current (e.g., real-time) position and orientation of the objects and the surrounding environment relative to the vehicle 10.

Referring still to FIGS. 7A-7C, the vehicle awareness system 500 of the vehicle may be configured to detect objects in a surrounding area of the refuse vehicle 10 that is proximate the refuse vehicle 10. In some embodiments, the vehicle awareness system 500 may include radar sensors 510 with sensing arcs 512 configured to detect objects in the surrounding area of the refuse vehicle 10. In some embodiments, the radar sensors 510 may be positioned on the exterior of the refuse vehicle 10 such that the sensing arcs 512 of the radar sensors 510 overlap to generate a 360-degree sensing area. In some embodiments, the radar sensors 510 are a combination of long and short-range sensors.

Referring still to FIGS. 7A-7CB, according to some embodiments, the vehicle awareness system 500 may include camera sensors 520 with sensing arcs 522. In some embodiments, the camera sensors 520 may be a visible light camera and/or an infrared light camera, which be positioned on the exterior of the refuse vehicle 10 such that the sensing arcs 522 of the camera sensors 520 overlap to generate a 360-degree sensing area. In some embodiments, the camera sensors 520 are a combination of narrow-angle sensors and wide-angle sensors.

Referring to FIGS. 7A-7CC, according to some embodiments, the vehicle awareness system 500 may include a combination of the radar sensors 510 with the sensing arcs 512 and the camera sensors 520 with the sensing arcs 522. The sensing arcs 512 of the radar sensors 510 and the sensing arcs 522 of the camera sensors 520 may combine to provide 360 or near-360-degree coverage of the perimeter of the vehicle. Additional or alternative sensors may be used in the vehicle awareness system 500. For example, the vehicle awareness system 500 may employ LiDAR sensors, ultrasonic sensors, time-of-flight sensors, infrared light sensors, etc.

It should be understood that the positioning and arrangement of the radar sensors 510 and the camera sensors 520 as described herein with reference to FIGS. 7A-7C is illustrative only and is not intended to be limiting. For example, any of the radar sensors 510 or the camera sensors 520 may be disposed on a top of the vehicle such that the radar sensors 510 or the camera sensors 520 are configured to detect the presence and relative distance or position of overhead objects, obstacles, etc., proximate the vehicle. The vehicle awareness system 500 may additionally process the perceived environment data to identify and label the various environmental objects surrounding the vehicle. For example, the vehicle awareness system 500 may include processing circuitry to identify a fence proximate a road the vehicle is travelling on. The vehicle awareness system 500 may identify the fence using one or more machine learning architecture, including various layers and functions. Once identified, the vehicle awareness system 500 may store associated information with the identified object, including a label the object, in a database or memory for transmission to one or more subsystems (e.g., a trajectory planning system) of the autonomy system.

In addition to perceiving the environment surrounding the vehicle and processing the received sensor data, the vehicle awareness system 500 may sense and record various operating parameters and data relating to the vehicle 10. For example, the vehicle awareness system 500 may determine and record a position and orientation (and associated movement) of the vehicle. By way of example, the vehicle awareness system 500 may record adjustments made manually or autonomously to the vehicle when traveling down a narrow alley. These adjustments may be recorded and/or transmitted to a trajectory planning system (e.g., the trajectory planning system 610 of FIG. 6) to be used in planning a future trajectory of the vehicle (e.g., a trajectory for the vehicle 10 to travel in a reverse direction).

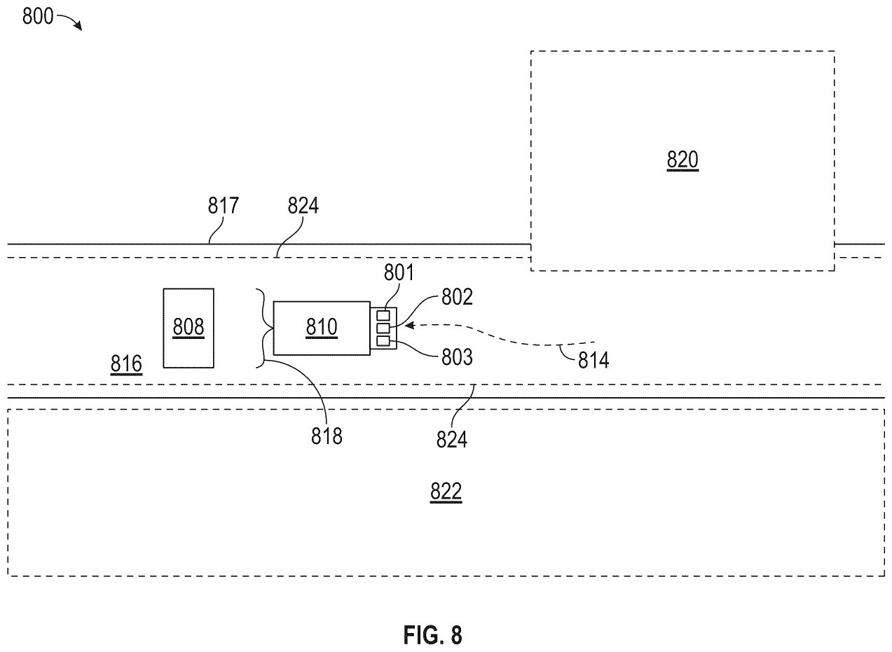

The vehicle awareness system 500 may additionally or alternatively perceive and identify bounds and thresholds non-drivable surfaces. For example, the vehicle awareness system 500 may identify non-drivable bounding areas surrounding the identified non-drivable surfaces. These non-drivable bounding areas may be transmitted to the trajectory planning system (e.g., the trajectory planning system 801 of FIG. 8) to use in planning a trajectory for the vehicle. The non-drivable bounding areas may be areas in which the vehicle 10 would collide into an identified obstacle. Additionally, or alternatively, the bounded non-drivable surfaces may be areas that the vehicle awareness system 500 determines are illegal or suboptimal for the vehicle 10 to travel in. Likewise, the vehicle awareness system 500 may process the received sensor data to determine and identify bounded drivable areas associated with drivable surfaces. Bounded drivable areas may include legal surfaces upon which the vehicle 10 may travel. In addition, bounded drivable areas may include areas in 3D space that the vehicle can travel without colliding into an object (or can travel with a sufficient safety threshold between the vehicle 10 and an obstacle or other bounded non-drivable surface). Both bounded non-drivable areas and bounded drivable areas may be 2D-bounded areas on a surface or may be 3D-bounded areas in 3D space. In addition to determining and identifying non-drivable bounding areas and bounded drivable areas, the vehicle awareness system 500 may determine and/or identify safety thresholds associated with the non-drivable surfaces or non-drivable bounding areas. These safety thresholds may also be transmitted to the trajectory planning system. The safety thresholds may be associated with a drivable or non-drivable surface and may correspond to an extreme position in 3D space where the vehicle may safely be located. The safety threshold may correspond to a position proximate (or near proximate) the identified non-drivable bounding area and provide a safety buffer for the vehicle from entering the non-drivable bounding area. The safety threshold may correspond with a location on the drivable surface that a tractive element of the vehicle may be positioned. Additionally, or alternatively, the safety threshold may be a location or area in 3D space. For example, the vehicle awareness system 500 may identify a safety threshold around a branch hanging over a drivable surface. In such an embodiment, the vehicle may collide with the overhanging branch while driving on a drivable surface. As such, a safety threshold is provided to avoid the collision. The safety threshold may be used in planning the trajectory (as described in FIG. 8) and/or in operating the vehicle (as described in FIG. 8).

The vehicle awareness system 500 may use various sensor data from the disclosed sensors to perceive the environment. Additionally, or alternatively, the vehicle awareness system 500 may process the received sensor data from the sensors to identify the non-drivable bounding areas, non-drivable surfaces, drivable surfaces, objects, etc.

### Trajectory Planning System

Turning now to FIG. 8, an exemplary embodiment an autonomy system 800. The autonomy system 800 may include an electronic device communicatively coupled to vehicle 810 (e.g., the refuse vehicle 10 of FIG. 1) and including one or more processors executing a trajectory planning system 801, a vehicle adjustment system 802, and/or a vehicle awareness system 803 (e.g., the vehicle awareness system 500 of FIGS. 7A-7C). The trajectory planning system 801 may be substantially similar to the trajectory planning system 610 of FIG. 6. In some embodiments, the electronic device and the vehicle 810 may be considered a single unit and may be referred to interchangeably.

The trajectory planning system 801 may autonomously plan a trajectory 814 (e.g., a back-up or reverse direction trajectory) for the vehicle 810. By way of example, the vehicle 810 may include an engagement assembly 818 (e.g., refuse container grabber, forks, etc.) configured to engage and manipulate an object 808 (e.g., a refuse container). The engagement assembly 818 may be used to couple (e.g., grab, pinch, surround, lift, dump, etc.) to the object.

The trajectory planning system 801 may be communicatively coupled with the vehicle awareness system 803. Through this communicative coupling, the trajectory planning system 801 may receive data from and/or transmit data to the vehicle awareness system 803. By way of example, the trajectory planning system 801 may receive an indication of the presence of an object from the vehicle awareness system 803. The vehicle awareness system 803 may transmit to the trajectory planning system 801 a class of the object 808 (e.g., what the object 808 is), a position of the object 808, an estimated weight of the object 808, an estimated volume of the object 808, an orientation of the object 808, a position of the vehicle 810, a trajectory of the vehicle 810, speed of the vehicle 810, an acceleration of the vehicle 810, a gear engagement of the vehicle 810, suspension stiffness of the vehicle 810, speed limit of a drivable surface 816 (e.g., a road), a time of day, a date, a pre-planned collection route (e.g., route 308 of FIG. 5), a location of a client's residence or address associated with the pre-planned collection route, client data, etc. The trajectory planning system 801 may use this received data to automatically plan the trajectory 814 for the vehicle 810.

The trajectory planning system 801 may use the received data from the vehicle awareness system 803 to determine, identify, and/or plan an optimal path of travel for the vehicle to engage with the object 808 and/or reverse out of a narrow drivable surface.

By way of example, the trajectory 814 planned by the trajectory planning system 801 may be a path for the vehicle 810 to travel in reverse. For example, the vehicle 810 may travel down an alley 817 on the drivable surface 816 to collect the object 808 (e.g., a refuse container). The drivable surface 816 may end and not allow space for the vehicle 810 to turn around and exit the alley 817 traveling forward. Consequently, the vehicle 810 must travel in the reverse direction to exit the drivable surface 816.

The trajectory planning system 801 may process the transmitted data from the vehicle awareness system 803 to identify the optimal path to exit in reverse the alley 817 without leaving the drivable surface, exceeding a safety threshold, and/or colliding with the surrounding environment. In some embodiments, the trajectory planning system 801 may include a collection stop along the trajectory 814. For example, the trajectory may include a position in which the vehicle 810 stops to collect the object 808 (e.g., a refuse container) associated with a client of an entity associated with the vehicle 810.

One or more of the trajectory planning system 801 and/or the vehicle awareness system 803 may autonomously operate the vehicle 810 along the trajectory 814. Additionally, or alternatively, the trajectory planning system 801 and/or the vehicle awareness system 803 can operate a display screen of an electronic device to provide an augmented reality or overlaid imagery of the trajectory 814 such that the operator of the vehicle 810 can transport the vehicle 810 along the trajectory 814.

In some embodiments, the vehicle awareness system 803 may transmit to the trajectory planning system 801 recorded data associated with a recorded movement of the vehicle 810 in travelling down the alley 817 on the drivable surface 816. For example, the vehicle awareness system 803 may transmit positional data of the vehicle 810 and corresponding operating parameters (e.g., speed, steering angle, direction of travel, etc.). The trajectory planning system 801 may receive this recorded data and use the recorded data to determine the trajectory 814. By way of example, the trajectory 814 may be a reverse of the recorded data for the vehicle 810 entering the alley 817.

### Vehicle Adjustment System

Referring still to FIG. 8, the vehicle 810 may include a vehicle adjustment system 802. The vehicle adjustment system 802 may adjust one or more operating parameters of the vehicle 810. The vehicle adjustment system 802 may adjust the one or more operating parameters of the vehicle 810 to operate the vehicle 810 along the trajectory 814 determined and planned by the trajectory planning system 801. The vehicle adjustment system 802 may directly control the one or more operating parameters of the vehicle 810 and/or transmit instructions to one or more subsystems of the vehicle 810 to cause the adjustment of the operating parameters. Operating parameters of the vehicle 810 may include, but are not limited to, a braking amount, a steering angle, an acceleration amount, a gear engagement, a suspension stiffness, an engagement assembly actuation, refuse container grabber actuation, a lift device actuation, a refuse collection actuation (e.g., opening a tailgate or trash chute), and a compaction apparatus. These operating parameters may be adjusted automatically in response to receiving the one or more signals.

In one embodiment, the vehicle awareness system 803 may record the movements and operating parameter adjustments of the vehicle 810 as it travels down the alley 817 on the drivable surface 816 in the forward direction. These recorded movements and operating parameter adjustments may be transmitted, compiled, aggregated, processed, by the vehicle awareness system 803 and transmitted to the vehicle adjustment system 802. The vehicle adjustment system 802 may then operate or cause to operate the vehicle 810 in a manner opposite of the recorded movements and operating parameter adjustments. For example, the vehicle adjustment system 802 may operate the vehicle 810 in the reverse of the recorded movement and operating parameter adjustments.

In another embodiment, the vehicle adjustment system 802 may assist an operator of the vehicle 810 in operating the vehicle 810 in reverse to exit the alley 817. For example, if an operator of the vehicle operates the vehicle past a safety threshold (e.g., exceeds the safety threshold) and approaches a bounded non-drivable surface, the vehicle adjustment system 801 may transmit a notification to an electronic device (e.g., mobile device, tablet, computer, server, database, onboard vehicle controller, etc.) associated with the operator of the vehicle 810 or the vehicle 810 itself (e.g., the controller 102 of FIG. 4). The notification may be a visual notification, a haptic notification, and/or an audio notification to notify the operator of vehicle and/or the vehicle adjustment system 802. For example, responsive to the vehicle operating to a point that exceeds a safety threshold 824, the vehicle adjustment system 802 (or the vehicle awareness system 803) may notify the operator through a notification that the vehicle 810 is in danger of a collision or driving on a bounded non-drivable surface. Alternatively, or additionally, the vehicle adjustment system 802 may cause a cessation of operations causing movement of the vehicle 810 responsive to exceeding the safety threshold 824. For example, the vehicle adjustment system 802 may transmit control signals to the vehicle 810 to apply a braking force, change a steering angle, adjust a gearing engagement, stop electrical power, etc.

In some embodiments, the autonomy system 800 receives an indication from a user input device (e.g., a display of the electronic device) from the electronic device indicating to initiate one or more components of the autonomy system 800. For example, an operator of the vehicle 810 may initiate the vehicle adjustment system 802 through an interaction with a user input device of the electronic device. By way of example, graphics or images may be displayed on the display of the electronic device to represent the planned trajectory 814, and the operator of the vehicle 810 may interact with a presented prompt on the display of the electronic device to accept the planned trajectory 814. Upon receiving an indication of the interaction with the display of the electronic device, the autonomy system 800 may initiate the vehicle adjustment system 802 to autonomously or semi-autonomously guide the vehicle 810 down the alley 817 in reverse along the trajectory 814 on the drivable surface 816. Additionally, or alternatively, the trajectory planning system 801 may present for approval various locations or trajectories for the operator to choose. Responsive to receiving an indication of a selection of a single location and/or trajectory, the vehicle adjustment system 802 may autonomously or semi-autonomously navigate the vehicle 810 along the selected trajectory to the selected location. In other embodiments, the operator may select on the user input device a location, area, and/or object to navigate to. Responsive to receiving the indication of the location, area, and/or object to navigate to, the 801 may identify an optimal trajectory to the selected location, are, and/or object. The vehicle adjustment system 802 may then cause adjustments to the operating parameters of the vehicle 810 to travel upon the planned trajectory.

The vehicle adjustment system 802 may include one or more selectable operating modes (e.g., an autonomous mode in which the vehicle makes all operating parameter changes of the vehicle 810, a semi-autonomous mode in which the vehicle aids the operator of the vehicle 810 in making one or more operating parameter adjustments, etc.). In some embodiments the display of the electronic device may present for display the bounded non-drivable area 822, the bounded non-drivable area 820, and/or the bounded drivable area 816. Additionally, or alternatively, one or more components of the autonomy system 800 may present for display on the electronic device a safety threshold 824. In some embodiments, the bounded non-drivable area 822 and the bounded non-drivable area 820 may be superimposed on one or more images captured by sensors or from a database. Bounded non-drivable area 820 may represent an area associated with a tree next to the alley 817. Bounded non-drivable area 822 may represent an area outside the drivable surface of the alley 817 (e.g., a sidewalk). Drivable surface 816 may also represent, and be displayed as, a bounded drivable area because it is the road.

In an autonomous mode, the user may override the autonomous adjustments by interacting with the user input device. For example, during the autonomous mode in which the vehicle adjustment system 802 is making autonomous adjustments to the operating parameters of the vehicle 810 to travel on the trajectory 814, the user may interact with one or more user input devices (e.g., a steering wheel, a brake, an accelerator, a display, etc.) to stop the autonomous adjustments and return manual control to the operator.

The vehicle adjustment system 802 and/or the trajectory planning system 801 may continually update the trajectory 814 and the execution of operating the vehicle 810 along the trajectory 814 based on continued reception of sensor data and environmental data from the vehicle awareness system 803.

In some embodiments, the autonomy system 800 may be used to plan and execute a trajectory of the vehicle 810 in a reverse direction to enter the alley 817 instead of exiting the alley 817.

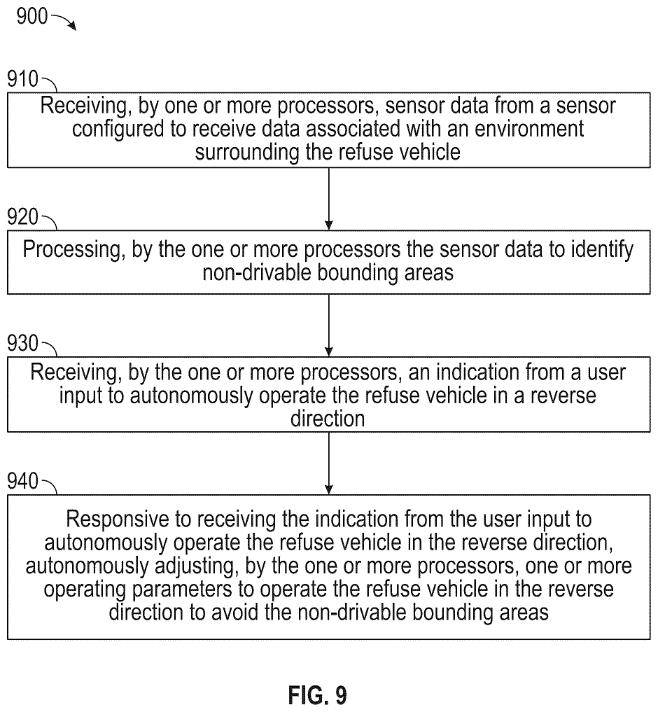

FIG. 9 is a flowchart of an example computer-implemented method 900 for guiding an operation of a refuse vehicle. At step 910, one or more processors receive sensor data from a sensor configured to receive data associated with an environment surrounding the refuse vehicle. At step 920, the one or more processors process the sensor data to identify non-drivable bounding areas. At step 930, the one or more processors receive an indication from a user input to autonomously operate the refuse vehicle in a reverse direction. At step 940, responsive to receiving the indication from the user input to autonomously operate the refuse vehicle in the reverse direction, autonomously adjust, by the one or more processors, one or more operating parameters to operate the refuse vehicle in the reverse direction to avoid the non-drivable bounding areas.

In some embodiments, the method 900 may include one or more additional or alternative correction actions responsive to receiving the indication that the vehicle is approaching a non-drivable bounding area (e.g., exceeding a safety threshold surrounding the non-drivable bounding area). Correction actions may include, but are not limited to, adjusting an operating parameter of the vehicle to avoid the non-drivable area, transmitting a notification of a potential collision to a user interface, and/or stopping movement of the vehicle.

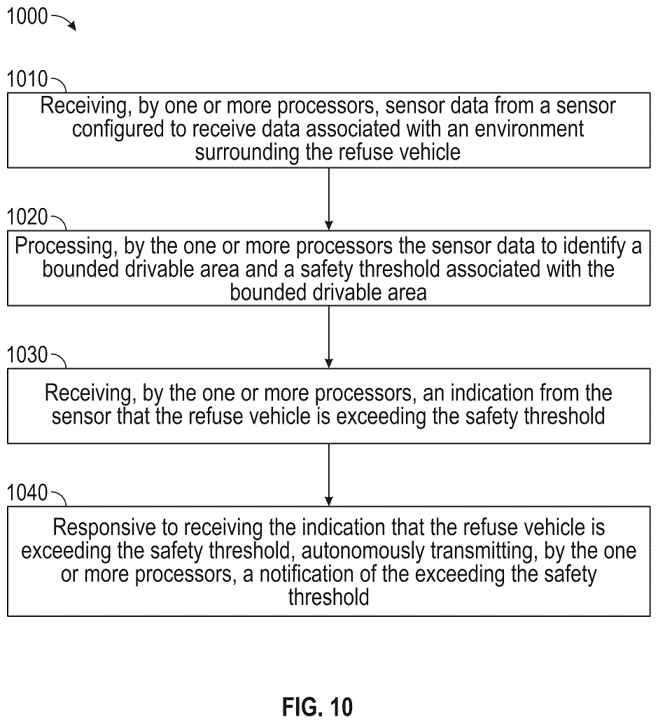

FIG. 10 is a flowchart of an example computer-implemented method 1000 for guiding an operation of a refuse vehicle. At step 1010, one or more processors receive sensor data from a sensor configured to receive data associated with an environment surrounding the refuse vehicle. At step 1020, the one or more processors process the sensor data to identify a bounded drivable area and a safety threshold associated with the bounded drivable area. At step 1030, the one or more processors receive an indication from the sensor that the refuse vehicle is exceeding the safety threshold. At step 1040, responsive to receiving the indication that the refuse vehicle is exceeding the safety threshold, autonomously transmit, by the one or more processors, a notification of the exceeding the safety threshold.

In the present disclosure, the terms system and server may be used interchangeably. The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such non-transitory computer-readable medium can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a user input device;
at least one tractive element;
at least one sensor configured to receive sensor data associated with an environment proximate the refuse vehicle;
at least one processor; and
a non-transitory computer-readable medium containing instructions that when executed by the at least one processor causes the at least one processor to:
receive the sensor data from the at least one sensor;
process the sensor data to identify a non-drivable bounding area;
receive an indication from the user input device to autonomously operate the refuse vehicle in a reverse direction; and
responsive to receiving the indication from the user input device to autonomously operate the refuse vehicle in the reverse direction, autonomously adjust one or more operating parameters of the refuse vehicle to operate the refuse vehicle in the reverse direction to avoid the non-drivable bounding area.

2. The refuse vehicle of claim 1, the at least one processor further configured to:
responsive to receiving a second indication from the user input device, end the autonomous adjustment of the one or more operating parameters.

3. The refuse vehicle of claim 1, wherein the non-drivable bounding area is associated with an overhead obstacle.

4. The refuse vehicle of claim 1, wherein the indication is associated with an instruction to engage a refuse container.

5. The refuse vehicle of claim 1, wherein the instructions further cause the at least one processor to:
process the sensor data to identify a bounded drivable area and a safety threshold associated with the bounded drivable area;
receive a second indication from the at least one sensor that the refuse vehicle is exceeding the safety threshold; and
responsive to receiving the indication that the refuse vehicle is exceeding the safety threshold, execute a correction action.

6. The refuse vehicle of claim 5, wherein the correction action includes autonomously adjusting, by the at least one processor, the one or more operating parameters to adjust a position of the refuse vehicle to be within the safety threshold.

7. The refuse vehicle of claim 5, wherein the correction action includes autonomously transmitting, by the at least one processor, a notification of the exceeding of the safety threshold.

8. The refuse vehicle of claim 7, wherein the notification is one of a visual notification, haptic notification, or audio notification.

9. The refuse vehicle of claim 5, wherein an engagement assembly of the refuse vehicle is exceeding the safety threshold.

10. A non-transitory computer-readable medium containing instructions that when executed by one or more processors, cause the one or more processors to:
receive sensor data from at least one sensor;
process the sensor data to identify a non-drivable bounding area;
receive an indication from a user input device to autonomously operate a refuse vehicle in a reverse direction; and
responsive to receiving the indication from the user input device to autonomously operate the refuse vehicle in the reverse direction, autonomously adjust one or more operating parameters of the refuse vehicle to operate the refuse vehicle in the reverse direction to avoid the non-drivable bounding area.

11. The non-transitory computer-readable medium of claim 10, wherein the instructions further cause the one or more processors to:
process the sensor data to identify a bounded drivable area and a safety threshold associated with the bounded drivable area;
receive a second indication from the at least one sensor that the refuse vehicle is exceeding the safety threshold; and
responsive to receiving the indication that the refuse vehicle is exceeding the safety threshold, execute a correction action.

12. The non-transitory computer-readable medium of claim 11, wherein the correction action includes autonomously adjusting, by the one or more processors, the one or more operating parameters to adjust a position of the refuse vehicle to be within the safety threshold.

13. The non-transitory computer-readable medium of claim 11, wherein the correction action includes autonomously transmitting, by the one or more processors, a notification of the exceeding of the safety threshold.

14. The non-transitory computer-readable medium of claim 13, wherein the notification is one of a visual notification, haptic notification, or audio notification.

15. The non-transitory computer-readable medium of claim 10, wherein the instructions further cause the one or more processors to:
responsive to receiving a second indication from the user input device, end the autonomous adjustment of the one or more operating parameters.

16. The non-transitory computer-readable medium of claim 10, wherein the non-drivable bounding area is associated with an overhead obstacle.

17. The non-transitory computer-readable medium of claim 10, wherein the indication is associated with an instruction to engage a refuse container.

18. A computer-implemented method for operating a refuse vehicle comprising:
receiving, by one or more processors, sensor data from at least one sensor;
processing, by the one or more processors, the sensor data to identify a non-drivable bounding area;
receiving, by the one or more processors, an indication from a user input device to autonomously operate the refuse vehicle in a reverse direction; and
responsive to receiving the indication from the user input device to autonomously operate the refuse vehicle in the reverse direction, autonomously adjusting, by the one or more processors, one or more operating parameters of the refuse vehicle to operate the refuse vehicle in the reverse direction to avoid the non-drivable bounding area.

19. The computer-implemented method of claim 18, further comprising:
processing, by the one or more processors, the sensor data to identify a bounded drivable area and a safety threshold associated with the bounded drivable area;
receiving, by the one or more processors, a second indication from the at least one sensor that the refuse vehicle is exceeding the safety threshold; and
responsive to receiving the indication that the refuse vehicle is exceeding the safety threshold, executing, by the one or more processors, a correction action.

20. The computer-implemented method of claim 19, wherein the correction action includes autonomously adjusting, by the one or more processors, the one or more operating parameters to adjust a position of the refuse vehicle to be within the safety threshold.
